(19) United States
(12) Patent Application Publication
(10) Pub. No.: US 2006/0186607 A1
(43) Pub. Date: Aug. 24, 2006

(54) Seal boot

(76) Inventors: Min-Fang Shih, Lu Kang Township (TW); Shou-Ling Lin, Lu Kang Township (TW)

Correspondence Address: RABIN & BERDO, P.C., Suite 500, 1101 14th Street, N.W., Washington, DC, 20005, US

(21) Appl. No.: 11/060,298

(22) Filed: Feb. 18, 2005

(51) Int. Cl. F16J 3/00

(52) U.S. Cl. 277/634

(57) ABSTRACT

A seal boot has on one side longitudinally formed a gap, the gap being provided with a zipper for fast and easy replacement of the seal boot and a grease nipple being disposed on the boot for direct refill of grease without breaking down the assembly of the propeller shaft.

### BACKGROUND OF THE INVENTION

(a) Field of the Invention

The present invention is related to a seal boot providing high economic effects of savings of time, efforts, and costs, and more particularly to one mounted to transmission or revolving mechanism of a motor vehicle or machine including a transmission shaft, a steering mechanism, a propeller shaft in a transmission box or in a differential mechanism.

(b) Description of the Prior Art

Development of motors or machinery industry particularly relies upon safety and reliability of a transmission. Improvements have been made to the design and manufacturing process of the transmission for upgrading the utility of the motor vehicle. The front transmission invented in 1920 by Rzeppa completely transmits the drawing force generated by an engine to a driving propeller shaft within a range of certain degrees. Later the front-wheel transmission has been gradually applied in the design of a motor vehicle. The propeller shaft assembly of the prior art as illustrated in FIGS. 9 and 10 of the accompanying drawings is essentially comprised of a driving/driven shaft (1), a propeller shaft (2), a rubber boot (3), and a clamp (4). The joint is the most critical part in the assembly of the propeller shaft (2). There are many types of joint. Among them, ball and trunnion type, and Rezppa type are the most common types. To keep the joint between the propeller shaft (2) and the driving/driven shaft (1) agile by fending off ingression of foreign matters. The seal boot (3) is provided to the propeller shaft (2) and fastened by means of the clamp (4) to the driving/driven shaft (1). However, after a certain length of time, the boot (3) will get crack and crisp due to oxidization. The spoiled boot (3) then will admit foreign matters resulting in leakage of grease, and thus damage to the entire propeller shaft.

In the event of the damaged boot or losing of grease from the propeller shaft, all the parts must be removed/replaced and restored making the service job time and efforts consuming while increasing the service charges.

### SUMMARY OF THE INVENTION

The primary purpose of the present invention is to provide a fast service and cost reduction seal boot by having longitudinal gap on one side of the boot and the gap is zipped.

Another purpose of the present invention is to provide a seal boot with a zipped gap on one side and a grease nipple disposed at a selected location of the boot to give mobile and in-time refill of grease directly into the propeller shaft including the universal joint.

### BRIEF DESCRIPTION OF THE DRAWINGS

FIG. 1 is a perspective view of a preferred embodiment of the present invention in its closed status.

FIG. 2 is a perspective view of the preferred embodiment of the present invention in its open status.

FIG. 3 is a perspective view of another preferred embodiment of the present invention of different size in its closed status.

FIG. 4 is a schematic view showing that a clamp is removed before disassembling the preferred embodiment of the present invention.

FIG. 5 is a schematic view showing that the preferred embodiment is displaced before its disassembly.

FIG. 6 is a schematic view showing that the preferred embodiment is pulled straight in the course of its disassembly.

FIG. 7 is a schematic view showing a fast removal of the preferred embodiment of the present invention.

FIG. 8 is a schematic view showing a location where the preferred embodiment is mounted to a propeller shaft of an automobile.

FIG. 9 is a perspective view showing a seal boot of the prior art is mounted to a propeller shaft of an automobile.

FIG. 10 is a perspective view of the seal boot of the prior art.

### DETAILED DESCRIPTION OF THE PREFERRED EMBODIMENTS

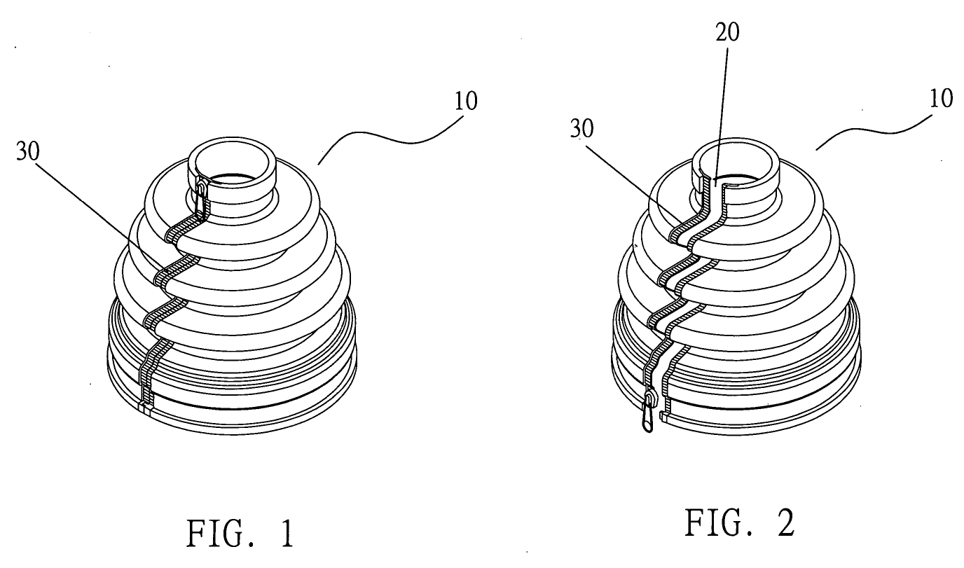

Referring to FIGS. 1 and 2, a seal boot (10) of a preferred embodiment of the present invention is made of rubber and has on one side a longitudinal gap (20) and a zipper (30) disposed to the gap (20).

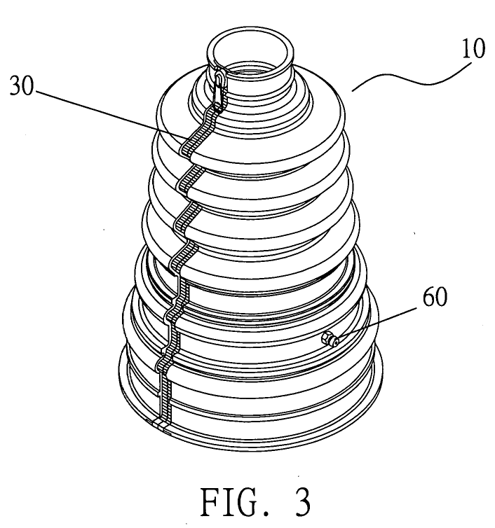

As illustrated in FIG. 3, a grease nipple (60) is provided at where appropriately on the boot (10). During service, the grease can be directly pumped into a propeller shaft (50) including a universal joint in the boot (10) without removing the boot (10) and the propeller shaft (50).

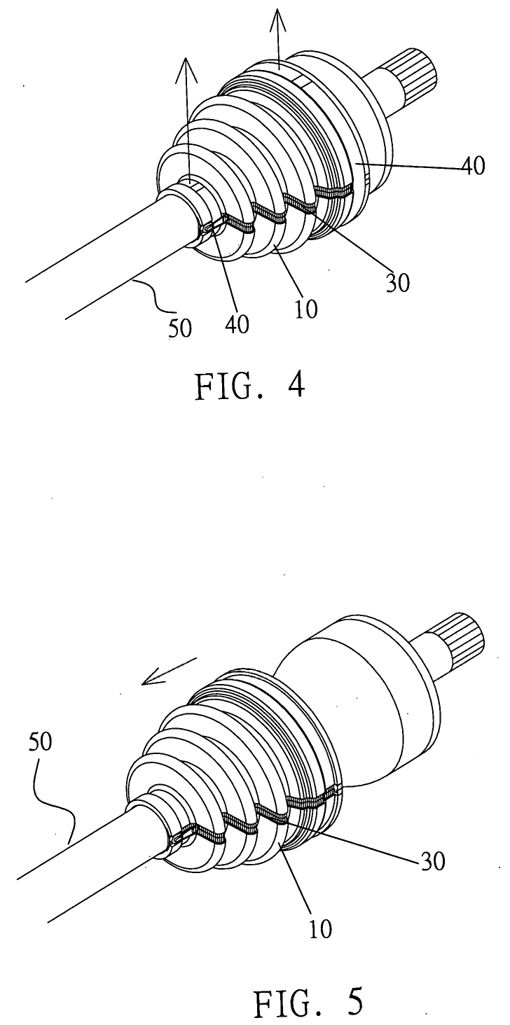

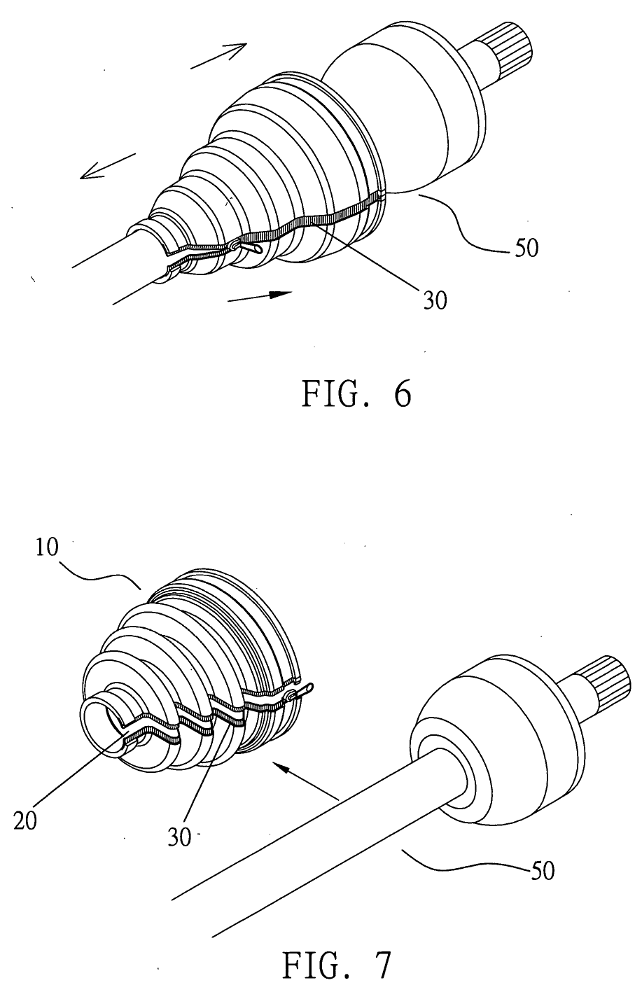

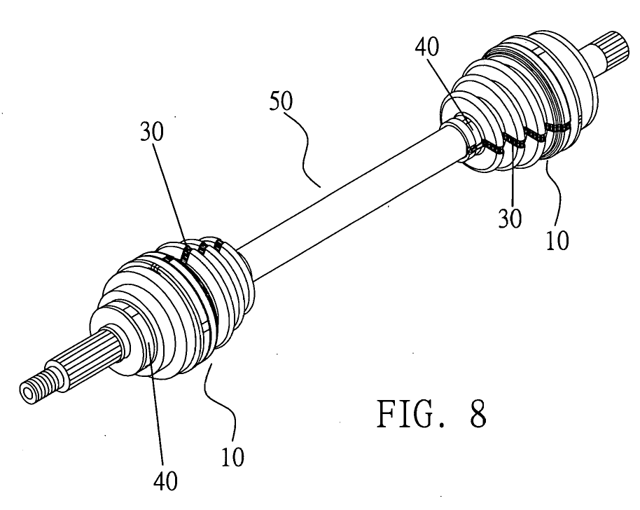

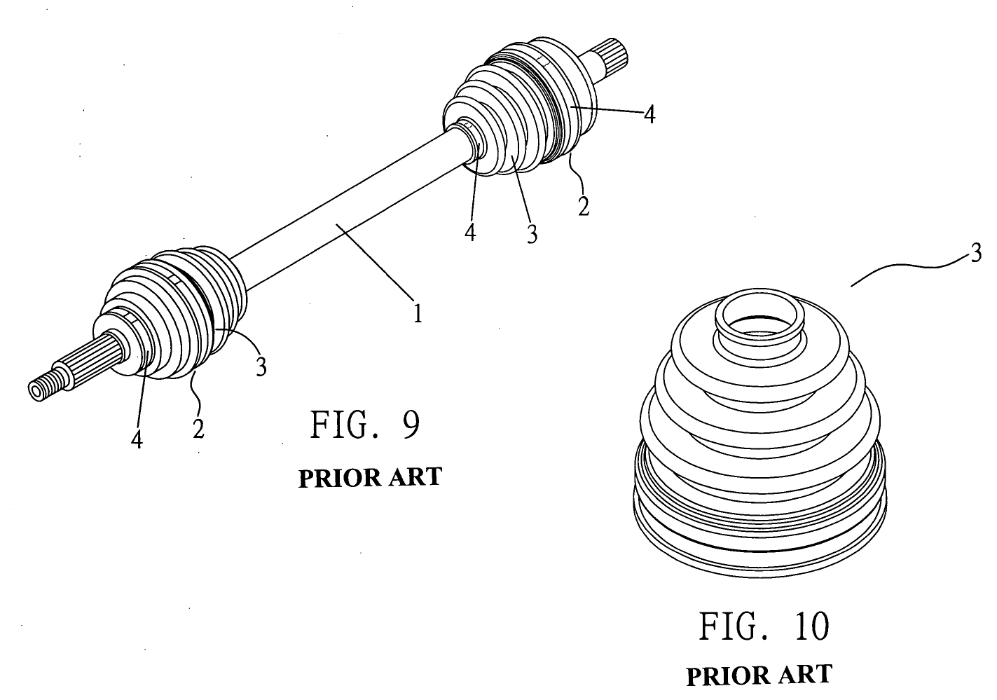

Now referring to FIGS. 4 through 8 for a replacement job of the boot (10), a clamp (40) securing the boot (10) is first removed from the propeller shaft (50), and then the boot (10) is displaced, pulled out, extended, unzipped at the gap (20) and removed. The present invention by permitting a fast removal of the boot (10) provides highly economic benefits by eliminating longer time, higher labor costs and expensive service charges as found with the prior art wherein the entire assembly of the propeller shaft must be disassembled in replacing a boot or service of any other mechanical part.

The present invention offers the following expected results:
1. The boot can be easily replaced without breaking down any parts for significant savings of time and money.
2. The grease nipple provided on the boot of the present invention allows direct refill of grease to maintain sufficient lubrication of the mobile parts, thus to extend their service lives and facilitate their operation.
3. It takes only ten minutes up to a quarter in replacing the boot while it takes one hour up to two hours for the boot of the prior art.

The prevent invention provides an improved construction of a seal boot that allows easy replacement and direct refill of grease for significant savings in time, efforts and cost. However, it is to be noted that that the preferred embodiments disclosed in the specification and the accompanying drawings are not limiting the present invention; and that any construction, installation, or characteristics that is same or similar to that of the present invention should fall within the scope of the purposes and claims of the present invention.

1. A seal boot has on one side longitudinally provided with a gap, and a zipper provided to the gap to zip or unzip the gap.

2. The seal boot of claim 1, wherein, a grease nipple is disposed at a selected location on the seal boot.
